(19) United States
(12) Patent Application Publication
(10) Pub. No.: US 2024/0343578 A1
(43) Pub. Date: Oct. 17, 2024

(54) HELIUM SEPARATION AND RECOVERY PROCESS

(71) Applicant: Arjae Design Solutions Ltd., Alberta (CA)

(72) Inventors: Ernie MAURIER, Alberta (CA); Daniel Adam SZUSZKIEWICZ, Alberta (CA); Stephen Paul JACKSON, Alberta (CA); Ryan James MEAD, Alberta (CA)

(73) Assignee: Arjae Design Solutions Ltd., Alberta (CA)

(21) Appl. No.: 18/606,018

(22) Filed: Mar. 15, 2024

Related U.S. Application Data
(60) Provisional application No. 63/452,936, filed on Mar. 17, 2023.

(51) Int. Cl. C01B 23/00; B01D 53/00; B01D 53/047; B01D 53/14; B01D 53/22; B01D 53/26; B01D 53/46; C01B 32/50; F25J 3/02

(52) U.S. Cl. CPC C01B 23/0094; B01D 53/002; B01D 53/047; B01D 53/1475; B01D 53/229; B01D 53/26; B01D 53/46; C01B 32/50; F25J 3/029; B01D 2251/102; B01D 2252/20431; B01D 2252/20447; B01D 2252/20489; B01D 2256/18; B01D 2257/102; B01D 2257/108; B01D 2257/504; B01D 2257/702; B01D 2257/80; C01B 2210/0004; C01B 2210/001; C01B 2210/0014; C01B 2210/0025; C01B 2210/0031; C01B 2210/0046; C01B 2210/0051; C01B 2210/0053; C01B 2210/0062; C01B 2210/007; F25J 2205/30; F25J 2205/40; F25J 2205/64; F25J 2205/80; F25J 2205/82; F25J 2210/20; F25J 2215/30; F25J 2220/02; F25J 2240/40; F25J 2270/30; F25J 2270/42; F25J 2270/58

(57) ABSTRACT

The present provides a helium gas separation and recovery process involving cryogenic fractionation process, which comprises cooling a dehydrated high-pressure gas stream while maintain velocity and pressure of the stream; reducing pressure of the dehydrated high-pressure gas stream via a Joule-Thompson's process to obtain a partially liquefied gas stream; and iii) subjecting the partially liquefied gas stream to at least one gas-liquid separation process to obtain at least one liquid stream and a gaseous stream comprising helium, and a residual amount of the gaseous components; recycling the liquid stream obtained in step iii) for use as cooling refrigerant to cool the dehydrated high-pressure gas stream; and purifying the unrefined helium gas stream using pressure swing adsorption (PSA) and/or membrane separation process to obtain a helium product stream having a purity of 98.0 mole % or more.

### CROSS-REFERENCE TO RELATED APPLICATIONS

This application claims the benefit of priority under 35 USC § 119 (e) of U.S. Provisional Patent Application 63/452,936, filed on Mar. 17, 2023, the contents of which are incorporated by reference as if fully set forth herein in their entirety.

### FIELD AND BACKGROUND OF THE INVENTION

The invention relates to the separation and recovery of helium from a non-combustible well gas. In particular to the separation and recovery of helium from nitrogen rich gas stream via a cryogenic fractionation process.

Helium (He) is a colorless and odorless inert gas with unique properties, and is the second most abundant element in the universe after that of hydrogen. Helium exists as a gas, except under extreme temperature conditions, and does not burn or react with other elements. Helium cannot be manufactured or synthesized, but can only be extracted from deep beneath the earth's surface where it is generated through radioactive decay of uranium and thorium. Helium is a non-renewable natural resource that is most commonly found in natural gas recovered from natural gas deposits. Most recently, helium has also been found in non-combustible gas recovered from geological deposits. These deposits can contain up to 5 percent helium concentration, with some deposits showing a promising of up to 7 percent helium concentration. These deposits contain a mixed gas that is high in nitrogen and low in hydrocarbons and carbon dioxide. The global benchmark for the economic recovery of helium from standalone wells are for gases with minimum helium concentration of 0.5%.

Several processes have been developed in the field for helium separation and recovery from various sources.

US Publication No. 2005/0217479 discloses processes for recovering helium from reject gas streams of various types that arise from natural gas processing. The process involves treating reject gas by membrane separation before it is sent to its ultimate destination. The membranes used in the treatment are selectively permeable in favor of helium over other gases in the stream, particularly nitrogen and hydrocarbon.

U.S. Pat. No. 4,701,200 discloses a process to produce helium gas from the feed to a nitrogen rejection unit comprising employing refrigeration from the nitrogen rejection unit to increase the recovery of helium by cooling crude helium prior to further processing.

U.S. Pat. No. 5,244,350 discloses a process for recovering helium from a gas stream, wherein a subquality nitrogen-rich natural gas stream containing more than 0.1% mole helium is counter currently extracted with a lean physical solvent to produce a rich solvent bottoms stream which is flashed twice to produce a methane-rich gas product and nitrogen-helium product which is then fed to at least one membrane unit. A reject nitrogen stream and crude helium stream are discharged from this unit.

U.S. Pat. No. 5,224,350 discloses a hybrid membrane and pressure swing adsorption process that can recover helium from source streams of about 0.5 to 5% by volume helium and concentrate the helium to a concentration of greater than about 98% by volume.

U.S. Pat. No. 8,152,898 B2 discloses a process where helium is recovered from gas streams containing high concentrations of hydrogen gas and low concentrations of helium gas using helium permeable membrane separator under conditions that selectively permit helium gas to permeate the membrane and forms a helium rich permeate gas stream.

U.S. Pat. No. 5,080,694 discloses a method for the extraction of helium from gases containing very low helium concentrations by an alternating pressure adsorption process. The helium containing gas is fed cyclically in each of three adsorption stages into four adsorbers connected in parallel. First hydrocarbons and other impurities are trapped in the adsorbers filled with activated charcoal. Other gaseous components, such as methane and nitrogen, are trapped in adsorbers filled with carbon molecular sieves, in two subsequent adsorption stages.

U.S. Pat. No. 5,329,775 discloses a cryogenic helium production system wherein a feed containing helium and carbon dioxide is processed in a dual temperature system including an upstream higher temperature and higher pressure column or dephlegmator.

Canadian Publication No. 3028675 discloses a method for the recovery of helium from natural gas using a three-stage membrane separation to produce a natural gas product and helium containing gas that may be injected into the reservoir from which the He-containing gas is obtained.

There is still a need for an improved helium gas separation and recovery method that can be operational and capital cost applicable for low production capacity, non-combustible, high nitrogen content gas wells with a helium concentration from between 0.5 mole % up to 5.0 mole %, and is capable of producing a helium sales with a purity of greater than 98.0 mole %, with a maximum purity of 99.999 mole % at helium recovery of greater than 99 wt %.

### SUMMARY OF THE INVENTION

An object of the present invention is to provide a helium gas separation and recovery process involving cryogenic fractionation process.

In accordance with an aspect of the present invention, there is provided a process for separating and recovering helium from a nitrogen rich gas feed stream comprising up to 10% mole of said helium. The process comprises: providing a high-pressure gas feed stream having a pressure from 300 to 3000 psi; removing CO₂ from the high-pressure gas feed stream to obtain a treated high-pressure gas stream; drying the treated high-pressure gas stream to obtain a dehydrated high-pressure gas stream; and subjecting the dehydrated high-pressure gas stream to a cryogenic fractionation process, which comprises i) cooling the dehydrated high-pressure gas stream through a heat exchanger; ii) reducing pressure of the dehydrated high-pressure gas stream to 100-200 psi via a Joule-Thompson's process to obtain a first partially liquefied gas stream comprising nitrogen and hydrocarbons, and gaseous components comprising He; and iii) subjecting the partially liquefied gas stream to at least one gas-liquid separation process to obtain at least one liquid stream comprising condensed nitrogen and/or condensed hydrocarbons, and an unrefined helium gas stream comprising helium and a residual amount of gaseous components comprising H₂, N₂, and Ar. The process further comprises step recycling the liquid stream obtained in step iii) of the fractionation process to the heat exchanger for use as cooling refrigerant to cool the dehydrated high-pressure gas stream via heat exchange; and purifying the unrefined helium gas stream using pressure swing adsorption (PSA) and/or membrane separation process to obtain a helium product stream having a purity of 98.0 mole % or more.

### BRIEF DESCRIPTION OF THE SEVERAL VIEWS OF THE DRAWINGS

Further features and advantages of the present disclosure will become apparent from the following detailed description, taken in combination with the appended drawings, in which:

FIG. 1 is a schematic flow diagram of helium separation and recovery process in accordance with an embodiment of the present invention.

FIG. 2 is a schematic flow diagram showing the cryogenic fractionation portion of the process depicted in FIG. 1.

FIG. 3 is a schematic flow diagram of helium separation and recovery process in accordance with another embodiment of the present invention.

FIG. 4 is schematic flow diagram showing the cryogenic fractionation portion of the process depicted in FIG. 3

FIG. 5 is a schematic flow diagram showing the components of the amine scrubbing system designed to remove CO₂ in the helium separation and recovery process in accordance with an embodiment of the present invention.

FIG. 6 is a schematic flow diagram showing the components of the molecular sieve dehydrators designed to remove the moisture from the feed gas in the helium separation and recovery process in accordance with an embodiment of the present invention.

FIG. 7 is a schematic flow diagram showing the pressure swing adsorption process involved in the helium separation and recovery process in accordance with an embodiment of the present invention.

FIG. 8 is schematic flow diagram showing the hydrogen oxidation process designed to oxidize and convert any residual hydrogen in the unrefined helium gas in the helium separation and recovery process in accordance with an embodiment of the present invention.

FIG. 9 is schematic flow diagram of a fuel gas production system involved in the helium separation and recovery process in accordance with an embodiment of the present invention.

The specific arrangements shown in the Figures should not be viewed as limiting. It should be understood that the illustrated elements, including and the shape, size and scale, are not drawn in actual proportion to each other.

### DESCRIPTION OF SPECIFIC EMBODIMENTS OF THE INVENTION

Unless defined otherwise, all technical and scientific terms used herein have the same meaning as commonly understood by one of ordinary skill in the art to which this invention belongs.

As used herein, the term “about” refers to a +/−10% variation from the nominal value. It is to be understood that such a variation is always included in a given value provided herein, whether or not it is specifically referred to.

The present invention relates a helium gas separation and recovery process that provides significant capital cost saving making it economically attractive to supply helium separation and recovery plants for low production capacity, non-combustible, high nitrogen content gas production wells with a helium concentration from between 0.5 mole % up to 5.0 mole % helium concentration.

The process of the present invention is capable of producing a helium sales gas with a purity of greater than 98.0 mole %, with a maximum purity of 99.999 mole % at helium recovery of greater than 99 wt %.

The process of the present invention involves a cryogenic fractionation process that is based on an integrated energy recovery design that utilizes the Joule-Thomson cooling effect from a cascaded pressure letdown of the high-pressure feed gas to a final atmospheric discharge pressure stream, coupled with heat recovery reducing the size and complexity of the cryogenic system, where the bulk nitrogen that is recovered from the well gas is used as the refrigerant.

Separation and bulk recovery of the nitrogen allows the helium to be concentrated into a smaller, more concentrated stream which is more economically treated in the downstream membrane and/or PSA process. The process is designed to fractionate the feed gas into three separate products: (1) hydrocarbon stream, (2) nitrogen stream, and (3) unrefined helium gas stream. The process utilizes the heat recovered from other parts of the process to minimize the energy required for liquefaction, such that no external energy input to the process is required.

The process of the present invention can be used to recover helium from a mixed source of feed gases. The invention can be used to separate and recover helium from natural gas or it can be used to recover helium from non-combustible well gas high in nitrogen. The gas is recovered and purified by a series of steps involving pre-treatment, cryogenic fractionation and membrane and/or pressure swing adsorption (PSA). Cryogenic fractionation, unlike that of prior art, utilizes the high well gas pressure and the resultant Joule-Thomson cooling effect to reduce the size and complexity of the cryogenic fractionation process.

The process of the present invention involves different gas separation technologies arranged in series so as produce a high purity helium sales gas (>98 mole %) in addition to concentrating the gas contaminants into high purity streams that can be monetized and/or used internal to the process to reduce both capital and operational cost.

Purified by-products from the recovery of helium include high purified streams of carbon dioxide, hydrocarbon condensate and fuel gas. The by-product fuel gas can be utilized within the process as a fuel supply to reduce operating cost. The ability of the invention to selectively separate and recover the hydrocarbon fraction component, in a composition equivalent to fuel gas, provides either an additional revenue opportunity for the user or can eliminate or reduce the process reliance on an external energy supply during steady state operation.

By-products that can be monetized include the production of a high purity carbon dioxide (>98 mole %) stream, that can be further purified through minimal additional treatment to produce a beverage food grade liquid CO₂. Hydrocarbons are recovered to produce a fuel gas equivalent that can be utilized within the process to eliminate the process's reliance on an external energy source during steady state operation. Similarly, heavy hydrocarbons, not suitable for use as a fuel gas, are recovered as a condensate that can be monetized as a sale by-product. The ability of the present invention to selectively separate and recover the hydrocarbon fraction component, in a composition equivalent to fuel gas, provides either an additional revenue opportunity for the user or can eliminate or reduce the process reliance on an external energy supply during steady state operation.

The cryogenic process is based on an integrated energy recovery design configured to utilize the Joule-Thomson cooling effect from a cascaded pressure letdown of the high-pressure feed gas to a final atmospheric discharge pressure for the bulk nitrogen effluent stream. It is a partial liquefaction process where a vast majority of the nitrogen is separated, recovered and used as the cooling refrigerant before vented to the atmosphere. Separation and bulk recovery of the nitrogen allows the helium to be concentrated into a smaller stream(s) that can be treated more economically in the downstream membrane and/or PSA processes.

The process of the present invention involves separating and recovering helium from nitrogen rich gas feed stream comprising up to 10% mole of said helium, and other components comprising CO₂, H₂, N₂, O₂, Ar and water. The process comprises providing a high-pressure gas feed stream having a pressure from 300 to 3000 psi and removing CO₂ from the high-pressure gas feed stream to obtain a treated high-pressure gas stream followed by drying the treated high-pressure gas stream to obtain a dehydrated high-pressure gas stream. The dehydrated high-pressure gas stream is then subjected to a cryogenic fractionation process, which involves cooling the dehydrated high-pressure gas stream through a heat exchanger while maintaining velocity and pressure, reducing pressure of the dehydrated high-pressure gas stream to 100-200 psi via a Joule-Thompson's process to obtain a first partially liquefied gas stream comprising condensed nitrogen and hydrocarbons, and gaseous components comprising He, followed by subjecting the partially liquefied gas stream to at least one gas-liquid separation process to obtain at least one liquid stream comprising condensed nitrogen and/or hydrocarbons, and an unrefined helium gas stream comprising helium, and a residual amount of the gaseous components comprising H₂, N₂, and/or Ar. The liquid stream obtained after the cryogenic fractionation is recycled to the heat exchanger for use as cooling refrigerant to cool the dehydrated high-pressure gas stream via heat exchange, and the unrefined helium gas stream is purified using pressure swing adsorption (PSA) and/or membrane separation process to obtain a helium product stream having a purity of at least about 98.0 mole %.

In some embodiments, the gas-liquid separation process comprises passing at least a portion of the first partially liquefied gas stream through a liquid absorber, wherein the at least one liquid stream comprises the condensed nitrogen and hydrocarbons. The liquid stream can be recycled to the heat exchanger for cooling the dehydrated high-pressure gas stream via heat exchange. In some embodiments, a slip stream from the dehydrated high-pressure gas stream is used for heating at least a portion of the liquid stream to vaporize and separate any residual helium from the liquid stream.

In some embodiments, the gas-liquid separation process comprises passing the first partially liquefied gas stream through a hydrocarbon absorber, to obtain a first liquid stream comprising condensed hydrocarbons, and a vapor stream comprising nitrogen, helium and other gaseous components. The vapor stream is cooled via passing through the heat exchanger and/or by reducing pressure of the vapor stream via a Joule-Thompson's process to obtain a second partially liquefied gas stream comprising condensed nitrogen, helium and other gaseous components. The second partially liquefied gas stream is then passed through a nitrogen absorber to obtain a second liquid stream comprising condensed nitrogen, and unrefined helium gas stream comprising helium and a residual amount of the gaseous components comprising H₂, N₂, and/or Ar.

In some embodiments, the process involves using a slip stream from the dehydrated high-pressure gas stream for heating at least a portion of the first liquid hydrocarbon stream to vaporize and separate any residual nitrogen from the liquid hydrocarbon stream.

In some embodiments, the process involves using a slip stream from the dehydrated high-pressure gas stream for heating at least a portion of the second liquid stream to vaporize and separate any residual helium from the liquid stream.

In some embodiments, the process further comprises recycling at least a portion of the first liquid stream and/or the second liquid stream to the heat exchanger for cooling the dehydrated high-pressure gas stream via heat exchange.

In some embodiments, at least a portion of the liquid hydrocarbons stream is further processed to obtain a fuel gas stream for use as a heat source within the process, and/or one or more heavy hydrocarbons are recovered from the liquid hydrocarbons stream as saleable byproduct(s).

In some embodiments, the process further involves passing the at least one liquid stream obtained after cryogenic fractionation through a level valve for pressure reduction for flashing and heating the liquid nitrogen within the heat exchanger to draw heat from the system.

In some embodiments, the process further involves reacting the unrefined helium gas stream with oxygen in the presence of a catalyst to convert the hydrogen and/or methane into water, and removing the produced water from the helium gas stream.

Membrane and/or PSA can be used separately or in combination to purify the unrefined helium gas stream.

In some embodiments only, PSA is used to purify the helium gas stream, wherein a multi-bed comprised of multi-layers of adsorbent media is used to adsorb and remove the contaminants to produce a helium sales gas with a purity of greater than 99%.

In some embodiments only membrane separation is used to purify the helium gas stream, wherein a two-stage or three-stage membrane separation unit is used to produce a helium sales gas with a purity of greater than 99%.

Helium losses can occur at each step of the gas processing and purification. To minimize helium losses, while achieving a greater than 99% recovery, blowdown/exhaust from the membrane and/or PSA unit(s) is recycled back to the cryogenic fractionation process. Contaminates in the recycle blowdown favourably concentrate in the liquid/nitrogen absorber bottoms effluent stream, while allowing helium with a lower boiling temperature, to be recovered in the overheads product stream.

Use of a nitrogen absorber allows for recovery of the bulk nitrogen for use as the cooling refrigerant, while avoiding contaminant build-up within the recycle loop. In this configuration, contaminants are rejected from the process with the nitrogen effluent stream.

In some embodiments, the process further involves compressing the unrefined helium gas stream prior to the PSA process.

In some embodiments, the pressure swing adsorption process is programmed to cycle through twelve separate steps before repeating the cycle, wherein each steps is designed to recycle a respective PSA exhaust stream back to the cryogenic fractionation step.

The process can further include gas pre-treatment process. In some embodiments, the pre-treatment process involve multiple operations, arranged in series, designed to remove specific contaminates in an order to optimize the downstream process unit efficiency, while producing high purity by-product streams that can be further monetized. Pre-treatment includes gas-liquid separation for water and condensate removal, amine scrubbing for carbon dioxide removal, molecular sieve dehydration for water removal, filtration for particle removal prior to cryogenic fractionation.

In some embodiments, the process involves recovering separated CO₂ and processing same to obtain a high purity CO₂ stream with purity of greater than 98% mole. The recovered carbon dioxide stream can be monetized, where through minimal additional purification; the carbon dioxide can be used in the production of food grade beverages.

In some embodiments, the CO₂ removal comprises contacting the high-pressure gas feed stream with a lean amine and/or passing through an absorption/adsorption media (such as molecular sieves, aka mole sieves).

In some embodiments, the process involves drying the treated high-pressure gas stream via passing the treated high-pressure gas stream through a moisture absorption and/or absorption media.

To gain a better understanding of the invention described herein, the following examples are set forth with reference to the accompanying drawings, which are not drawn to scale, and the illustrated components are not necessarily drawn proportionately to one another. It will be understood that these examples are intended to describe illustrative embodiments of the invention and are not intended to limit the scope of the invention in any way.

### EXAMPLES

### Example 1

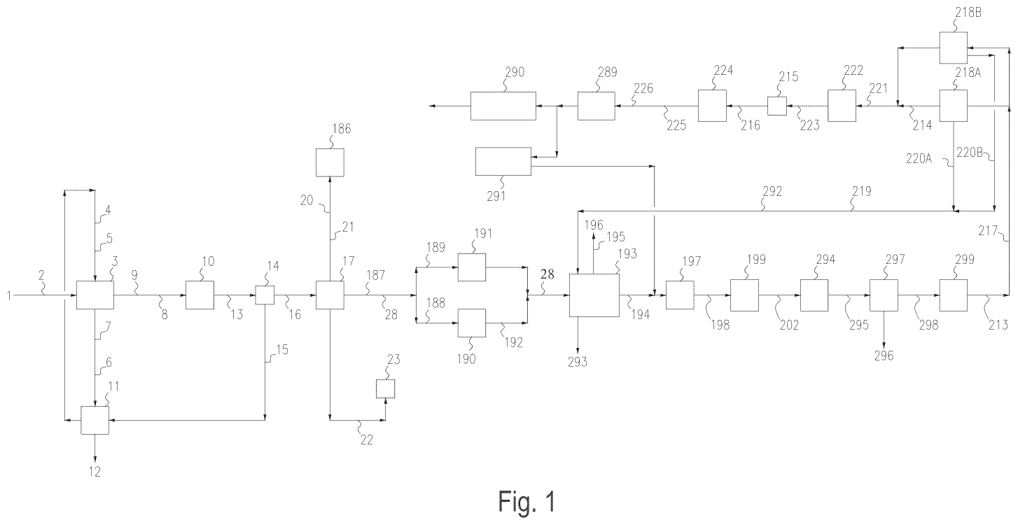

Referring to FIG. 1, a nitrogen rich non-combustible high-pressure feed gas (1), comprising a mix gas composition including helium, nitrogen, carbon dioxide, argon, hydrogen and a mix of hydrocarbons, flows via line (2) into an amine contactor (3), which is the first step of the gas pre-treatment process involving the removal of CO₂ from the high-pressure feed gas. CO₂ removal from the feed gas is accomplished by scrubbing the high-pressure feed gas with a blend of methyldiethanolamine (MDEA) & piperazine (4) or equivalent, also referred to as lean amine, that enters the amine contactor (3) via line (5), from where the lean amine flows counter current to the feed gas flowing through the amine contactor (3). The lean amine and feed gas are contacted, wherein CO₂ is absorbed into the lean amine to produce a rich amine solution (6) that exits from the amine contactor (3) via line (7) and flows into an amine regeneration unit (11).

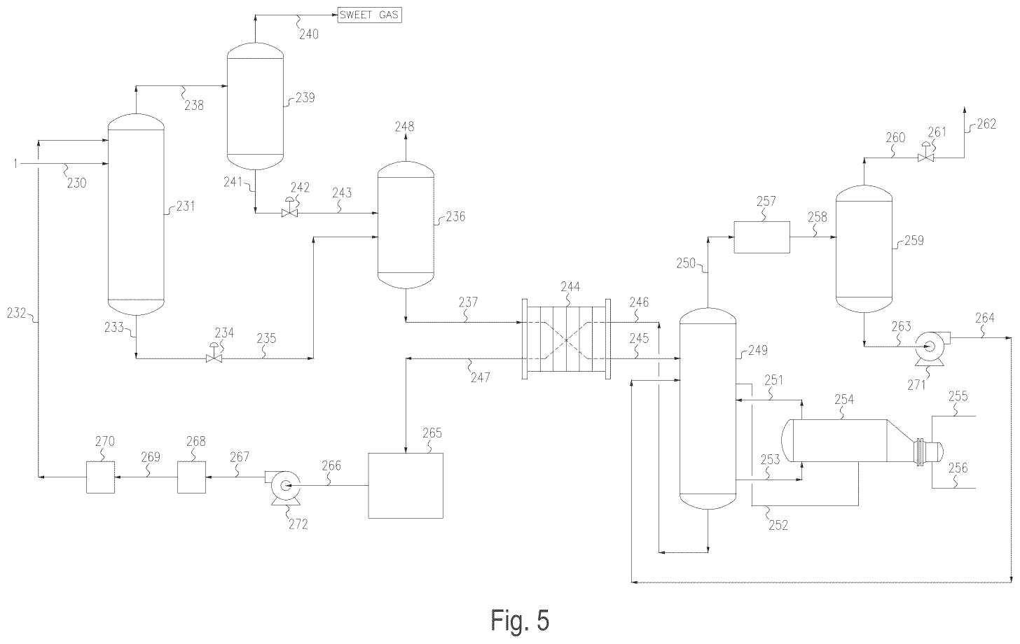

Amine scrubbing of the inlet feed gas removes a majority of the CO₂ in the gas, where the resultant concentration of CO₂ in the saturated sweet gas exiting the amine scrubber can be small within the parts per million by volume range, for example, <50 ppmv. CO₂ removal by amine scrubbing allows for the recovery of a high purity CO₂ stream (>98% mole) that can be further monetized, while simultaneously avoiding CO₂ freezing issues in downstream cryogenic fractionation process. Rich amine solution (6) recovered from the amine contactor can be regenerated within the amine regeneration unit (11) (further described in detail with reference to FIG. 5) to produce a lean amine solution (4) that is recycled back to the amine contactor for re-use as a scrubbing fluid. while the CO₂ is released and vented from the process as a high purity (>98 mole %) concentrated CO₂ stream (12) that can be further monetized as a by-product in production of saleable liquid CO₂.

Following CO₂ removal, the treated feed gas (8), also referred to a saturated sweet gas, exits from the amine contactor via line (9). The saturated sweet feed gas (8), can be optionally passed through the gas/gas exchanger (10) via line (9), where heat can be exchanged between the feed gas (1) and the saturated sweet feed gas (8), and the saturated sweet gas is cooled before entering via line (13) into a sweet gas scrubber (14) for the removal of any residual amine solution that is carried over and condensed as part of the cooling process. Any residual amine solution that is condensed is collected in the sweet gas scrubber (14) and retuned by line (15) to the amine solution regeneration unit (11) for re-use as a scrubbing solution.

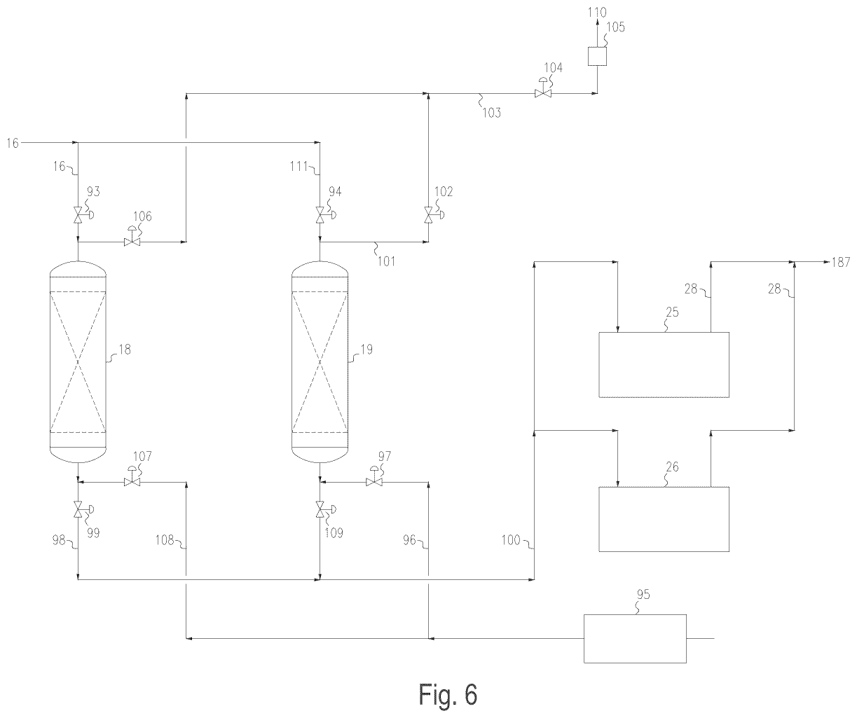

Following the amine scrubbing for CO₂ removal, the sweet gas is water saturated, requiring further dehydration prior to the cryogenic fractionation process to avoid water freezing. Saturated sweet gas (8) is passed into a sweet gas scrubber (14) via line (13), and then into a molecular sieve dehydration unit (17) via line (16). The molecular sieve dehydration unit (17) comprises two beds, where one bed is always in adsorption mode and the second bed is always in regeneration mode, where each bed cycles from adsorption and regeneration. In this example, once one of the bed completes an adsorption cycle, it is first depressurized, followed by regeneration utilizing effluent nitrogen (20) that is heated using the regeneration gas heater (186) from where it flows via line (21) to the molecular sieve dehydration unit (17). This effluent nitrogen (20) is free of any helium and is therefore an ideal regeneration gas stream as it does not result in any helium losses from the process. This effluent nitrogen (20), following bed regeneration, is discharged via line (22) directly to atmosphere via a silencer (23), where discharging the effluent nitrogen in this manner does not require a regeneration gas compressor as is utilized in a typical conventional molecular sieve dehydration unit (17). The mole sieve dehydration unit is discussed in detail with reference to FIG. 6.

From the mole sieve dehydration unit (17), the dehydrated/dry sweet gas (28) flows via line (187) and optionally subjected to dust filtration, wherein the sweet gas is divided into two separate lines (188 & 189) before flowing into two dust filters (190 & 191) arranged in parallel. The dust filters are designed to remove any particulate carryover from the molecular sieve dehydration unit (17) into a cryogenic fractionation system (193).

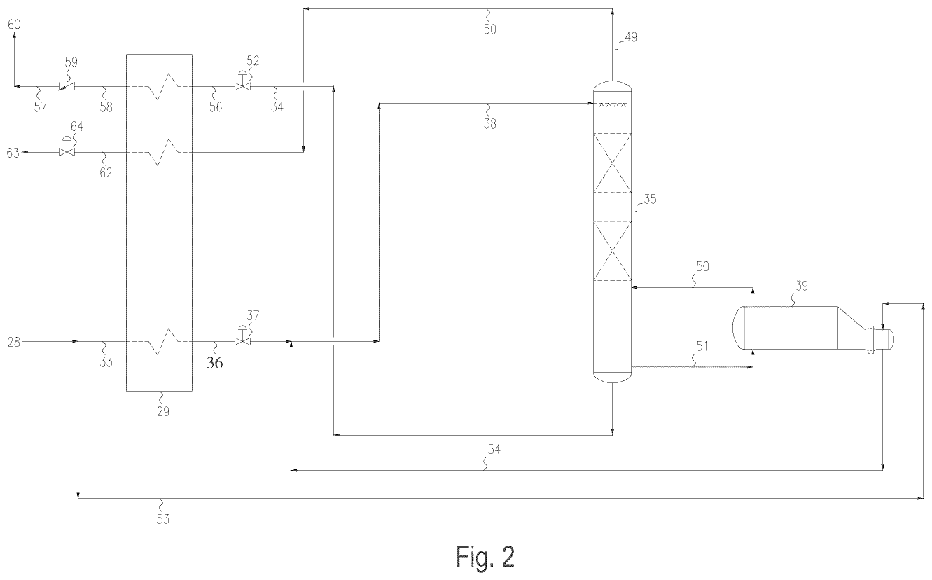

The cryogenic fractionation system and process used in this example is depicted in FIG. 2.

The cryogenic fractionation process of this example is designed to fractionate the dehydrated sweet gas (28) into two primary products, that being effluent liquid stream comprising condensed hydrocarbons and nitrogen, and a gaseous stream comprising helium gas and residual amounts of nitrogen, argon and hydrogen (also referred to as unrefined helium gas stream). To achieve this, the cryogenic fractionation process involves a liquid absorber (35) equipped with a reboiler (39). The gaseous stream comprising the helium gas and residual amounts of nitrogen, argon and hydrogen, all of which are not condensable within the nitrogen absorber, exits the cryogenic fractionation system via line (194).

The unrefined helium gas stream from the cryogenic fractionation system (193) flows via line (194) into an optional PSA booster compressor system that includes a PSA booster compressor accumulator (197) and a PSA booster compressor (199). The unrefined helium gas stream flows into the PSA booster compressor accumulator (197)) via line (194), from where it flows via line (198) into the PSA booster compressor (199).

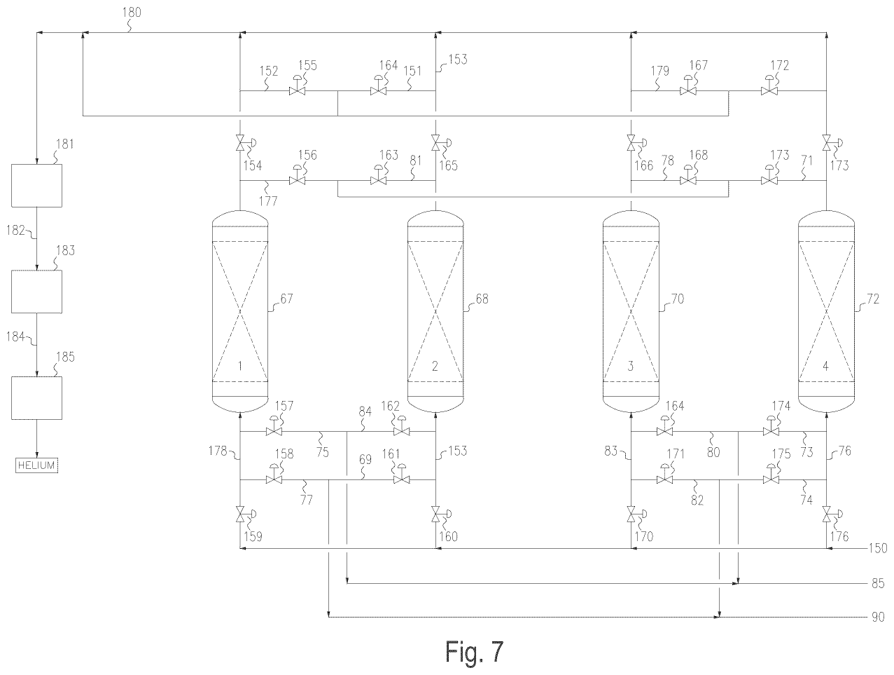

The PSA booster compressor (199) boosts the pressure of the unrefined helium gas stream from where it flows via line (202) into a PSA pressure swing adsorption (PSA) unit (218A) and/or a membrane separation unit (218B). The PSA unit (218A) is discussed in detail with reference to FIG. 7. The PSA unit can have four beds arranged in parallel. During normal operation each bed can cycle through a series of multiple modes of operation that can comprise adsorption, depressurization to atmospheric, pressurization, purging and depressurization under vacuum.

The exhaust (219) from the PSA unit (218A) and/or the membrane separation unit (218B) can be recycled via lines (220A, 220B) back to the liquid absorber within the cryogenic fractionation system (193), from where the contaminants with the exception of helium are condensed and removed within the liquid nitrogen and hydrocarbon stream from where it is eventually vented and released to the atmosphere via line (293).

Contaminants such as CO₂ and lower hydrocarbons that are not monetized can be vented with the nitrogen to the atmosphere. The recycling of the exhaust from the PSA unit (218A) and/or the membrane separation unit (218B) allows the process to achieve a greater than 99.5% mole helium recovery for the process.

From the PSA unit and/or the membrane separation unit, the helium sales gas (214) flows via line (221) into a helium filter (222), designed to remove any particulate carryover from the PSA and/or membrane separation unit. From the helium filter (222), the helium sales gas flows via line (223) into a helium sales gas accumulator (215), designed to provide surge capacity within the system, before flowing via line (216) into a helium loading compressor system (224), designed to pressurize and load tube trailers (290) with sales gas (226) via line (225). In this example, the PSA unit is designed to purify the dehydrated, unrefined helium gas into the helium sales gas with purity greater than 99.999% mole.

Optionally, the helium sale gas (226) can be subject to a lube oil removal system (289) prior to loading into the load trailers.

A portion of the helium sales gas (226) can be stored in a storage vessel (291) and added via line (292) to the unrefined helium gas stream exiting the cryogenic fractionation system via line (194) prior to passing through the PSA booster compressor system.

In some embodiments, the unrefined helium gas stream flowing via line (202) is passed through a lube oil removal system (294) and then into a hydrogen/methane catalyst reactor (296) via line (295). The catalyst reactor (296) is supplied with instrument air (297) for converting the hydrogen and/or methane in the unrefined helium gas stream into water, for removal of the contaminant hydrogen and/or methane from the helium gas as part of the purification process. Both the water and the treated unrefined helium gas exit the catalyst reactor (296) vial line (298) and dehydrated in a molecular sieve dehydration unit (299).

The dehydrated, unrefined helium gas stream (213) then flows via line (217) into the PSA unit (218A) and/or the membrane separation unit (218B).

FIG. 2 illustrates the cryogenic fractionation process of the helium separation and recovery process depicted in FIG. 1. In the first step, the sweet dehydrated gas (28) flows via line (187) into the bottom section of a brazed aluminum heat exchanger (29) where it is cooled and partially liquified. From the brazed aluminum heat exchanger (29), the cooled partially liquefied gas is passed via line (36) into a Joule-Thomson (JT) valve (37), located downstream of the heat exchanger (29), from where the pressure reduction to cause a Joule-Thompson cooling effect of the gas flowing through the JT valve (37) further partially liquefies the sweet dehydrated gas (28) achieving condensation of nitrogen and hydrocarbon components from the bulk nitrogen/helium to form a partially liquefied gas stream. Velocity and pressure of the partially liquefied gas, prior to entering the JT valve (37) is maintained by size reduction of line (36).

The partially liquefied gas stream is passed via line (38) into the liquid absorber (35), which separates the bulk liquid nitrogen and hydrocarbons from the helium and non-condensable components, The liquid absorber (35) is configured to produce a liquid stream comprising liquid nitrogen and hydrocarbons (which is then used as the principal cooling refrigerant in the cryogenic fractionation process), and a vapour/gaseous overhead stream (50) comprising helium along with residual amounts of nitrogen, argon and hydrogen (also referred to as unrefined helium gas stream). The vapour/gaseous overhead stream (50) exits from the top of the liquid absorber via line (49), and the liquid stream exits via line (34) from the bottom of the liquid absorber (35).

In order to limit or remove amount of carryover of helium in the liquid nitrogen and hydrocarbons, the liquid stream, before leaving via line (34) from the bottom of the liquid absorber (35), is directed to the reboiler (39) via line (51). A slip stream of the sweet dehydrated gas (28) is allowed to by-pass the heat exchanger (29) to flow via line (53) directly into the reboiler (39), where the residual heat in the sweet dehydrated gas (28) is used to boil the liquid nitrogen & hydrocarbons to generate a vapour/gaseous overhead stream (50) comprising the helium gas and residual amounts of nitrogen, argon and hydrogen. The slip stream of sweet dehydrated feed gas used to reboil the liquid in the reboiler (39) is returned via line (54) to be blended with the partially liquefied gas stream.

This process configuration minimizes the energy required for liquefaction as no external energy is required to be inputted into the process. All required energy input as heat to the reboiler (39) is recovered as thermal energy that is then used for of cooling of the sweet, dehydrated inlet gas.

The separated and recovered liquid nitrogen & hydrocarbons effluent liquid stream flows out of the bottom of the liquid absorber (35) via line (34) through level valve (52) into line (56) and then into the brazed aluminum heat exchanger (29). Level valve (52) is used for pressure reduction and level control in the liquid absorber that in turn permits flashing and heating of the liquid nitrogen within the brazed aluminum heat exchanger (29), drawing heat from the system to allow for cryogenic fractionation. The partially flashed liquid stream leaves the brazed aluminum heat exchanger (29) via line (58) and passes through butterfly valve (59) into line (57) out through vent (60). Butterfly valve (59) is an adjustable valve that can be used to control the degree of cooling within the brazed aluminum heat exchanger (29).

This valve can be closed to increase cooling across the heat exchanger or further opened to decrease cooling across the heat exchanger. The liquid nitrogen is fully flashed and vaporized downstream of the brazed aluminum heat exchanger (29) and butterfly valve (59) where the gas is vented to safe location in the atmosphere. The liquid nitrogen undergoes further pressure reduction via pressure reducing level valve (52) prior to going through the energy recovery step in the brazed aluminum heat exchanger (29) that provides the vast majority of the cooling duty necessary to liquefy the sweet, dehydrated feed gas into the cryogenic fractionation process.

The unrefined helium gas stream (50) exits from the top of the liquid absorber (35) via line (49) to flow into the brazed aluminum heat exchanger (29) where the gas is heated before flowing via line (62) through pressure valve (64) that is designed to regulate the gas flow into the PSA booster compressor system via line (194) comprising the PSA booster compressor accumulator (197) and the PSA booster compressor (199). Downstream of the PSA booster compressor accumulator (197), the helium unrefined vapour overhead gas stream is optionally flow ratio blended with dry instrument air which can be supplied by an instrument air system, after which the blended gas enters via line (198) into the suction of the PSA booster compressor (199). The dry instrument air is added to provide necessary oxygen required to convert the hydrogen in the unrefined helium gas stream into water. The PSA booster compressor boosts the unrefined helium gas stream exiting the PSA booster compressor accumulator (197) to an operating pressure between 100 to 300 psi.

### Example 2

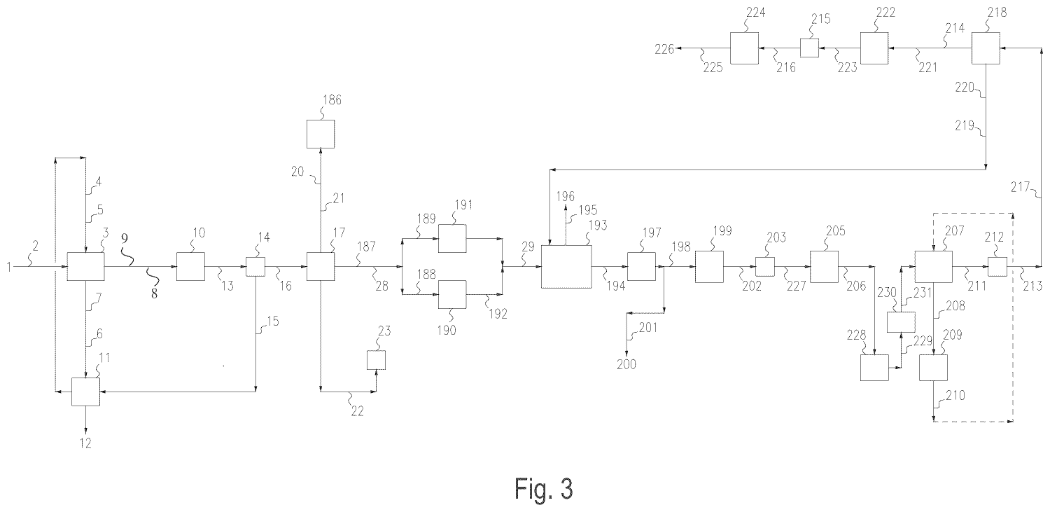

With reference to FIG. 3, the process of this example is similar to the process of example 1 depicted in FIG. 1 up to generation of the dehydrated sweet gas (28), which is subjected to a cryogenic fractionation process via line (187), and differs in the cryogenic fractionation process and the subsequent steps up to the treatment of the unrefined helium gas stream in PSA unit and/or membrane separation unit.

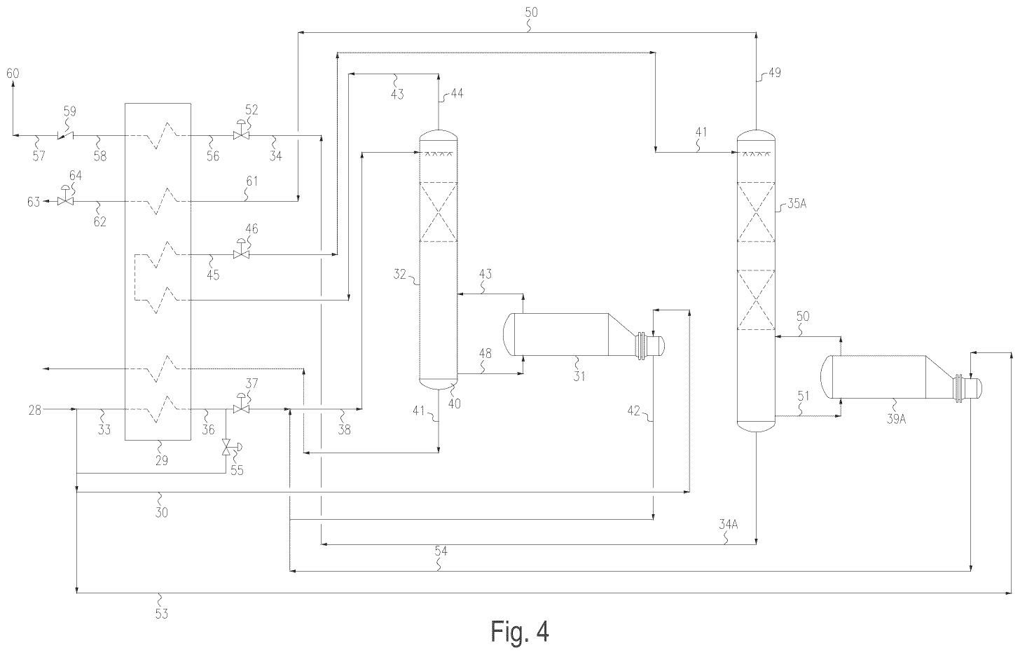

The cryogenic fractionation process of this example is designed to fractionate the dehydrated sweet feed gas (28) into three primary products; that being hydrocarbons, bulk liquid nitrogen effluent, and unrefined helium gas stream. To achieve this, the cryogenic fractionation process includes a methane/hydrocarbon absorber (32) equipped with a reboiler (31) and a nitrogen absorber (35A) equipped with a reboiler (39A). The cryogenic process involved in this example is depicted in greater detail in FIG. 4.

The unrefined helium gas stream from the cryogenic fractionation process flows via line (194) into the PSA booster compressor system, which includes a PSA booster compressor accumulator (197) and a PSA booster compressor (199). The unrefined helium gas stream prior to entry into the PSA booster compressor (199) can be flow ratio blended with dry instrument air (200) via line (201), which supplies the oxygen required for converting hydrogen and/or methane in the feed gas into water, for removal of the contaminant hydrogen and/or methane from the helium gas as part of the purification process. The PSA booster compressor (199) boosts the pressure of the blended unrefined helium gas stream from where it flows via line (202) into a hydrogen reactor preheater (203), where the gas is heated between 95 and 400 deg F. prior to flowing via line (227) into a hydrogen oxidation reactor (205).

The unrefined helium gas stream, and the oxygen from the dry instrument air flows through a catalyst media, wherein the hydrogen is oxidized by reaction with the oxygen to convert the hydrogen into water. Both the water and treated unrefined helium gas stream exit the hydrogen oxidation reactor (205) via line (206) from where it flows through aerial cooler (228), where the gas is cooled to condense the water derived from conversion of the hydrogen. From the aerial cooler (228), the gas flows via line (229) into the helium dehydration separator (230), designed to separate and remove the condensed water from the gas stream. From the helium dehydration separator (230), the gas flows via line (231) into a molecular sieve dehydration unit (207), designed to remove any remaining residual moisture in the gas stream.

The molecular sieve dehydration unit (207) comprises two beds complete with a series of automated open or close valves on the inlet and outlet of each bed designed to allow the beds to cycle back and forth between adsorption and desorption, also referred to as regeneration. To regenerate the mole sieve beds, cooled dehydrated gas (208) from downstream of the mole sieve dehydration unit (207) is recycled and heated using the helium regeneration heater (209), from where it flows via line (210) into the mole sieve dehydration unit (207) for bed regeneration. From the mole sieve dehydration unit (207), the dehydrated, unrefined helium gas flows via line (211) into the helium dust filter (212), designed to remove any particulate carryover from the mole sieve dehydration unit (207). From the helium dust filter (212), the dehydrated, unrefined helium gas (213) flows via line (217) into the PSA pressure swing adsorption (PSA) unit (218A) and/or membrane separation unit (218B), which are same as discussed in example 1. The steps after the treatment in the PSA unit (218A) and/or membrane separation unit (not shown), are same as discussed in with respect to FIG. 1 to obtain the pure helium gas.

FIG. 4 illustrates the cryogenic fractionation process involved in the helium separation and recovery process depicted in FIG. 3. In the first step, a portion of the sweet, dehydrated gas (28) (also referred to as inlet feed gas) flows via line (33) into the bottom section of the brazed aluminum heat exchanger (29) where the gas is cooled and partially liquefied. From the brazed aluminum heat exchanger (29), the cooled partially liquefied gas flows via line (36) into the JT valve (37), located downstream of the heat exchanger (29), from where the pressure reduction to cause a Joule-Thompson cooling effect of the gas flowing through the JT valve (37) further partially liquefies the inlet feed gas for achieving an optimal separation of C1+ components from the bulk nitrogen/helium stream within the methane/hydrocarbon absorber (32). The process is configured to allow an operator to select the intermediate pressure to which the inlet feed gas is finally reduced to so as to achieve the desired optimal separation of C1+ components from the bulk nitrogen/helium stream based on the inlet feed gas composition. Velocity and pressure of the partially liquefied gas, prior to entering the JT valve (37) is maintained by size reduction of line (36).

Following pressure reduction, the partially liquefied gas steam flows via line (38) into the hydrocarbon absorber (32), which is designed to separate and recover the hydrocarbons that have been cooled and condensed to produce a liquid stream (40) comprising C1+ hydrocarbon components in addition to some residual liquefied nitrogen, and a first vapour/gaseous overhead stream (43) comprising helium and the other contaminates less the hydrocarbons. The partially liquefied gas from the brazed aluminum heat exchanger (29) and the JT Valve (37) can enter near the top of the hydrocarbon absorber (32) column as a cold reflux.

To control and limit the nitrogen concentration in the liquid hydrocarbon stream exiting the hydrocarbon absorber (32), the liquid stream (40) is directed to the hydrocarbon reboiler (31) via line (48). A first slip stream of the sweet dehydrated gas (28) is allowed to by-pass the heat exchanger (29) to flow via line (30) directly into the hydrocarbon reboiler (31), where the residual heat in the sweet dehydrated gas (28) is used for reboiling of the liquid hydrocarbons in the liquid stream (40) from the absorber (32) to generate the first vapour/gaseous overhead steam (43).

The liquid hydrocarbon stream (40) flows from the bottom of the hydrocarbon absorber column via line (41) back into the brazed aluminum heat exchanger (29) where the cold liquid hydrocarbon stream is used for inlet feed gas cooling, from where only the light end hydrocarbon component, suitable for use as a fuel gas, of the liquid hydrocarbon stream is vaporized and recovered as a fuel gas in the fuel gas skid.

The slip stream of dehydrated sweet gas used to reboil the liquid hydrocarbon in the hydrocarbon reboiler (31) is returned to the inlet of the hydrocarbon absorber (32), following cooling via line (42) where it is blended with the partially liquefied gas stream directed to hydrocarbon separation and recovery.

The liquid hydrocarbons can be further processed within a fuel gas skid to separate the light hydrocarbons for use as a fuel gas internal to the process and the heavy hydrocarbons as a recovered condensate that can monetized as a saleable by-product.

The vapour/gaseous overhead stream (43) that leaves the top of the hydrocarbon absorber (32) comprises nitrogen, helium and other gaseous components contained in the inlet feed gas. This vapor overhead stream flows from top of the hydrocarbon absorber (32) via line (44) into the brazed aluminum heat exchanger stream (29), where the stream is partially liquefied through gas cooling, after which the partially liquefied gas stream flows via line (45) into the second JT Valve (46) from where the fluid system pressure is further reduced using the Joule-Thompson cooling effect of JT valve (46) to further condense and liquefy the nitrogen in the vapor overhead stream prior to form a second partially liquefied gas stream flowing via line (47) into the nitrogen absorber (35A) as cold reflux.

The nitrogen absorber (35A) separates the bulk liquid nitrogen from the gaseous components in the second partially liquefied gas stream, to form a liquid nitrogen stream, which exits via line (34A) from the bottom of the liquid absorber (35A), and a gaseous overhead stream comprising helium with residual amounts of nitrogen, argon and hydrogen (also referred to as unrefined helium gas stream), which exits from the top of the nitrogen absorber via line (49), as an unrefined helium gas stream (50). The object of this partial liquefaction step is to remove the vast majority of nitrogen as a bulk removal step for use as the cooling refrigerant and to concentrate the helium into a smaller product stream which is more economically treated in the downstream pressure swing adsorption unit.

The liquid nitrogen stream from the liquid absorber (35A) is used as the principal cooling refrigerant in the cryogenic fractionation process. The nitrogen is derived through separation and recovery of the nitrogen contamination from within the inlet feed gas.

To remove and limit the amount of carryover of helium in the liquid nitrogen, the liquid nitrogen stream, before leaving via line (34A) from the bottom of the nitrogen absorber (35A) is reboiled whereby liquid nitrogen flows via line (51) into the nitrogen absorber reboiler (39A) to have the liquid nitrogen cross exchange with the warmer dehydrated sweet feed gas stream (28) from the mole sieve dehydration unit, where the residual heat in the warmer sweet, dehydrated feed gas stream is used for reboiling of the liquid nitrogen.

Similar to the hydrocarbon absorption process, prior to entering the brazed aluminum heat exchanger (29) another slip stream portion of the dehydrated feed gas (28) is allowed to by-pass the heat exchanger (29) to flow via line (53) directly into the nitrogen absorber reboiler (39A), where the residual heat in the dehydrated sweet feed gas (28) is used to boil the liquid nitrogen in the nitrogen reboiler (39) to generate an unrefined helium gas stream comprising residual amounts of nitrogen, argon and hydrogen. The slip stream of sweet, dehydrated feed gas used to reboil the liquid nitrogen absorber reboiler is returned to the inlet of the hydrocarbon absorber (32), following cooling via line (54) where it is blended with the partially liquefied gas directed for hydrocarbon separation and recovery.

A temperature by-pass valve (55), upstream of the brazed aluminum heat exchanger (29) is programmed to open to always ensure the reboiler duty to both hydrocarbon reboiler (31) and nitrogen reboiler (39) is controlled to generate a sufficient overhead vapour, that is of the desired composition and rate such that greater than 99.9% of the helium is recovered as an overhead unrefined vapour overhead product (50) from the nitrogen absorber (35A).

The separated and recovered liquid nitrogen effluent flows out of the bottom of the nitrogen absorber (35A) via line (34) from where the liquid nitrogen flows through level valve (52) into line (56) and then into the brazed aluminum heat exchanger (29). Prior to entering the brazed aluminum heat exchanger (29) the liquid nitrogen first flows through level valve (52) for pressure reduction and level control in the nitrogen absorber that in turn permits flashing and heating of the liquid nitrogen within the brazed aluminum heat exchanger (29), drawing heat from the system to allow for cryogenic fractionation. The partially flashed nitrogen stream leaves the brazed aluminum heat exchanger (29) via line (58) and passes through butterfly valve (59) into line (57) out through vent (60). Butterfly valve (59) is an adjustable valve that is used to control the degree of cooling within the brazed aluminum heat exchanger (29). This valve can be further closed to increasing cooling across the heat exchanger or further opened to decrease cooling across the heat exchanger. The liquid nitrogen is fully flashed and vaporized downstream of the brazed aluminum heat exchanger (29) and butterfly valve (59) where the gas is vented to safe location in the atmosphere. The liquid nitrogen undergoes further pressure reduction via pressure reducing level valve (52) prior to going through the energy recovery step in the brazed aluminum heat exchanger (29) that provides the vast majority of the cooling duty necessary to liquefy the sweet, dehydrated feed gas into the cryogenic fractionation process.

This process configuration minimizes the energy required for liquefaction as no external energy is required to be inputted into the process. All required energy input as heat to hydrocarbon reboiler (31) and nitrogen reboiler (39A) is recovered as thermal energy that is then used for of cooling of the sweet, dehydrated inlet gas.

The unrefined helium overhead gas stream (50) that exits from the top of the nitrogen absorber (35A) via line (49) contains the helium from the feed gas that flows via line (61) into the brazed aluminum heat exchanger (29) where the gas is heated before flowing via line (62) through pressure valve (64) that is designed to regulate the gas flow via line (63), into the PSA booster compressor system comprising the PSA booster compressor accumulator (197) and a PSA booster compressor (199). The PSA booster compressor boosts the unrefined helium overhead gas (50) exiting the PSA booster compressor accumulator (197) to an operating pressure between 100 to 300 psi. From the PSA booster compressor (199), the blended helium unrefined vapour overhead gas flows via line (202) into the hydrogen reactor preheater (203).

FIG. 5 illustrates the gas sweeting process. High-pressure nitrogen rich non-combustible well gas (1) containing helium flows via line (230) into an amine contactor (231). The gas upon entering the contactor is scrubbed in a counter-flow manner with lean amine that enters via line (232) near the top of the amine contactor. Carbon dioxide in the inlet feed gas is removed upon contact with the lean amine producing a saturated sweet feed gas which exist from the top of the amine contactor via line (238), and rich amine solution that exits from the bottom of the amine contactor via line (233) from where rich amine flows through a level valve (234) designed to control the liquid level in the contactor, from where it then flows via line (235) into the amine flash drum (236). Any light ends or non-condensables are flashed and exit the top of the amine flash drum via line (248) where they are vented. Rich amine that is recovered in the amine flash drum leaves the bottom of the drum from where the solution flows via line (237) into rich amine/lean amine heat exchanger (244), from the residual heat in the lean amine that enters the rich amine/lean amine heat exchanger via line (246) is cross exchanged with rich amine solution. Rich amine solution leaves the rich amine/lean amine heat exchanger from where solution flows via line (245) into the amine regenerator (249). The amine regenerator (249) is equipped with an amine reboiler (254) designed to boil the rich amine solution to release the CO₂ that was absorbed during amine scrubbing within the amine contactor. Rich amine flows into the amine reboiler via line (252) where it is boiled using a heat medium that flows into the tube side of the reboiler via line (255), followed by exiting the reboiler via line (256). CO₂ that is released via boiling the rich amine solution exits out through the top of the amine reboiler where it flows via line (251) into the amine regenerator (249). Once in the amine regenerator (249), the CO₂ vapor flows up through and out from the top of the column via line (250) into the amine reflux condenser (257), designed to cool the overhead vapors. From the amine reflux condenser (257), the cooled overhead vapors flows via line (258) into the amine reflux drum (259) from any carryover amine solution that is condensed from cooling is captured as a liquid from where it flows via line (263) into a pump (271) from where it is recycled back to the amine regenerator via line (264). The non-condensable overhead vapor, comprising a high purity (>98% mole) CO₂, flows out of the top of the amine reflux drum (259) via line (260) through a pressure control valve (261) where it is then vented (262) to safe location in the atmosphere. Lean amine solution that exits from the bottom of the amine regenerator via line (246) from where it flows through the rich amine/lean amine heat exchanger (244) out through line (247) into the amine surge tank (265). From the amine surge tank, the lean amine solution flows via line (266) into a pump (272) from where it is pumped through an aerial cooler (268) via line (267) after which the solution flows through an amine filter (270) via line (269) before flowing back into the amine contactor (231) via line (232). The saturated sweet feed gas can be optionally passed through the gas/gas exchanger (239) via line (238), where heat can be exchanged between the feed gas (1) and the saturated sweet feed gas. The saturated sweet feed gas exits the gas/gas exchanger via line (240). Any residual amine condensed in the gas/gas exchanger is directed to the amine flash drum (236) via line (241) through a valve (242)

FIG. 6 illustrates the mole sieve dehydration process. The mole sieve dehydration unit comprises two beds equipped with a series of automated open or close valves on the inlet and outlet of each bed designed to allow the beds to cycle back and forth between adsorption and desorption, also referred to as regeneration. Located on the inlet of bed A (18) and bed B (19) are automated open and close valves, with automated valve A (93) located on the inlet of bed A and automated valve B (94) located on the inlet of bed B. When bed A (18) is in the adsorption mode, saturated sweet gas flows via line (16) into bed A, where the moisture within the gas is removed through adsorption onto the media. The dehydrated sweet gas flows out through the bottom of bed A via line (98) through automated valve B (99) in the open position into two dust filters (25 & 26) via line (100) designed to remove any particulate carryover in the gas. Simultaneously, hot regeneration gas (also referred as regen gas), comprising a nitrogen gas stream, from the regeneration heater (95) flows via line (96) through the automated valve E (97) in the open position on the bottom of bed B (19). The hot regen gas upon contact with the media in bed B (19) causes the adsorbed moisture to be vaporized and carried out through the top of bed B via line (101) through automated valve F (102) into a vent manifold (103). Located on the vent manifold is a pressure valve (104) designed to regulate both the backpressure within the bed and flow out through the silencer (105) before the regen gas (110) is discharged to a safe location in the atmosphere. Each bed is equipped with a pressure differential transmitter configured to measure the pressure loss across the bed. When the pressure loss in bed A, while in the adsorption mode, reaches its set-point pressure, bed A would automatically switch over from adsorption mode to regeneration mode. To do so, automated valve A (93) would close, while automated valve C (106) would open, similarly, automated valve B (99) would close, while automated valve D (107) would open, and allowing hot regen gas to flow via line (108) in through the bottom of bed A to regenerate the media. At the same time bed B would automatically switch over to from regeneration mode to adsorption mode. To do so, automated valve E (97) would close, while automated valve G (109) would open, similarly, automated valve F (102) would close, while automated valve H (94) would open, allowing saturated sweet gas to flow via line (111) in through the top of bed B for moisture removal from the sweet gas.

Following moisture removal, the dehydrated gas flows via line (100) into a series of dust filters, A (25) & B (26) for removal any carryover particulate in the gas stream from the molecular sieve dehydration unit (17).

Following particle removal, the sweet, dehydrated gas flow flows via line (187) into the cryogenic fractionation process.

FIG. 7 illustrates the pressure swing adsorption process for helium sales gas purification. The PSA units comprises four beds arranged in parallel. During normal operation each bed can cycle through a series of multiple modes of operation that include adsorption, depressurization to atmospheric, pressurization, purging and depressurization under vacuum. The following description describes how each bed can operate for one cycle of operation. Each PSA bed is equipped with multiple automated inlet and outlet values on the inlet and outlet manifolds of each bed that are programmed to open and close on a time sequence to change the mode of operation of each bed. For one cycle of operation there are 12 distinct steps of individual bed mode operation. In step 1, the dehydrated, unrefined helium gas stream enters the PSA unit via line (150) into bed 1 (67), where bed 1 is operating in the adsorption mode (valves 159 & 154 are open), while bed 2 (68) is depressurizing into the vacuum header via line (69) (valve 161 is open) and while bed 3 (70) is being repressurized via line (71) from the outlet gas of bed 4 (72) (valve 168 & 173 are open). In step 2, bed 1 (67) continues to operate in the adsorption mode (valves 159 & 154 are open), while bed 2 (68) is receiving purge gas from bed 4 (72) via line (71) (valves 173 & 163 are open), while bed 3 (70) is being pressurized with helium sales gas via line (83) (valves 170 & 166 are open). In step 3, bed 1 (67) continues to operate in the adsorption mode (valves 159 & 154 are open), while bed 2 (68) is being purged using helium sales gas via line (151) (valves 164, 165 & 160 are open), while bed 3 (70) is placed in standby mode, while bed 4 (72) is being depressurized into the atmospheric header via line (73) (valves 174 is open). In step 4, bed 1 (67) is partially depressurized into bed 2 (68) via line (177) (valves 156 & 163 are open), while bed 3 (70) is in the adsorption mode being pressurized with helium sales gas via line (83) (valves 166 & 170 are open), and bed 4 (72) in being depressurized into the vacuum header via line (74) (valves 175 is open). In step 5, bed 1 (67) is partially depressurized into bed 4 (72) via line (177) (valves 156 & 173 are open), while bed 3 (70) continues to operate in the adsorption mode. In step 6, bed 1 (67) is depressurized to the atmospheric header via line (75) (valve 157 is open, while bed 2 (68) is placed in standby, while bed 3 (70) continues to operate in the adsorption mode and bed 4 (72) is being purged with helium sales gas via line (76). In step 7, bed 1 (67) is now depressurized into the vacuum header via line (77) (valve 158 is open), while bed 2 (68) is in the adsorption mode being pressurized with helium sales gas via line (153) (valves 160 & 165 are open), while bed 3 (70) is depressurized into bed 4 (72) via line (71) (valves 168 & 173 are open). In step 8, bed 1 (67) is being purged using the outlet gas from bed 3 (70) via line (78) (valves 168 & 156 are open), while bed 2 (68) continues to operate in the adsorption mode (valves 160 & 165 are open), while bed 4 (72) is being pressurized with helium sales gas via line (79) (valve 172 is open). In step 9, bed 1 (67) is being purged with helium sales gas via line (152) (valve 155 is open), while bed 2 (68) operates in the adsorption mode (valves 160 & 165 are open), while bed 3 (70) is being depressurized pressurized into the atmospheric header via line (80) and bed 4 (72) is placed in standby mode. In step 10, bed 1 (67) is being pressurized using the outlet gas from bed 2 (68) via line (81) (valves 156 & 163 are open), while bed 3 (70) is being depressurized into the vacuum header via line (82) (valve 171 is open) and bed 4 (72) is operating in the adsorption mode (valves 173 & 176 are open). In step 11, bed 1 (67) is being pressurized using helium sales gas via line (178), while bed 2 (68) is being depressurized into bed 3 (70) via line (81) (valves 163 & 168 are open) and bed 4 (72) is operating in the adsorption mode (valves 173 & 178 are open). In step 12, bed 1 (67) is placed in standby mode, while bed 2 (68) is being depressurized into the atmospheric header via line (84) (valve 162 is open), while bed 3 (70) is being purged with helium sales gas via line (179) (valve 167 is open) and bed 4 (72) is operating in the adsorption mode (valves 173 & 178 are open). The cycle is repeated at the end of each 12 step mode operation. Purified helium sales gas leaves the PSA unit where it flows via line (180) in the PSA after filter (181) and then via line (182) into the PSA accumulator (183) and then via line (184) into the PSA loading compressor (185).

The adsorbent media can be operated for a time in a medium to high pressure adsorption state. During this period of time, molecules that are considered to be contaminants are adsorbed onto the media. Once the bed is saturated with the contaminants, its operation in the adsorb mode would stop and the bed would begin a series of desorb steps where the contaminants are removed using the series of depressurization steps described previously. The first step is to reduce the beds pressure to atmospheric pressure. This is followed by a vacuum evacuation step. The bed is then repressurized and returned to a ready to adsorb mode. To accommodate the time required to desorb contaminants on the bed, several beds can be operated on a rotating sequence, thereby allowing for one bed to be in the adsorption mode at any given time.

To maximize helium recovery the outlet exhaust gas from the beds when they are being depressurized into the atmospheric header line flows via line (85) into the PSA exhaust recycle unit which consists of a recycle compressor accumulator, PSA recycle compressor and PSA recycle compressor discharge accumulator. The PSA recycle compressor boosts the outlet exhaust gas pressure from where the exhaust gas flows via line back to the nitrogen absorber where it is blended with the inlet feed gas prior to purification.

Similarly, to maximize helium recovery the outlet exhaust gas from the beds when they are being depressurized into the vacuum header line flows via line (90) into the vacuum pump. The vacuum pump boosts the outlet exhaust gas pressure from where the exhaust gas flows via line into the PSA exhaust recycle unit which consists of a recycle compressor accumulator, PSA recycle compressor and PSA recycle compressor discharge accumulator. The PSA recycle compressor boosts the outlet gas pressure from where the gas flows via line back to the nitrogen absorber where it is blended with the inlet feed gas prior to purification.

An exemplary embodiment of the invention is how the process has been configured to recover up to 99.9 wt % of helium in the feed gas as a helium sales gas. This is achieved, as previously discussed, through the recycling of the PSA exhaust gas derived from the depressurization of the PSA beds back into the cryogenic fractionation process. Comprising mostly of helium and nitrogen with trace amounts of contaminants, where the trace contaminants include any hydrocarbons, CO₂, argon, and neon, the PSA exhaust is recycled back to the nitrogen absorber, where the trace contaminants are separated, condensed and recovered within the liquid nitrogen stream that is used cooling refrigerant used for gas cooling. The residual helium in the PSA exhaust leaves the top of nitrogen absorber with unrefined helium gas stream where the trace contaminants associated with this stream are those compounds that do not condensed that includes, along with the helium, hydrogen and neon. Contaminants, such as argon, CO₂ and any residual hydrocarbons, that are condensed and recovered in the liquid nitrogen stream are vented to the atmosphere with the nitrogen in heating and flashing across the brazed aluminum heat exchanger. Hydrogen that is not condensed and recovered within the liquid nitrogen stream within the nitrogen absorber is carried through with the unrefined helium gas stream. To remove hydrogen from the helium stream, the hydrogen is reacted with air with the aid a catalyst. The reaction of hydrogen with air would convert the hydrogen into water which then can be removed using a mole sieve dehydrator located downstream of the hydrogen oxidation reactor.

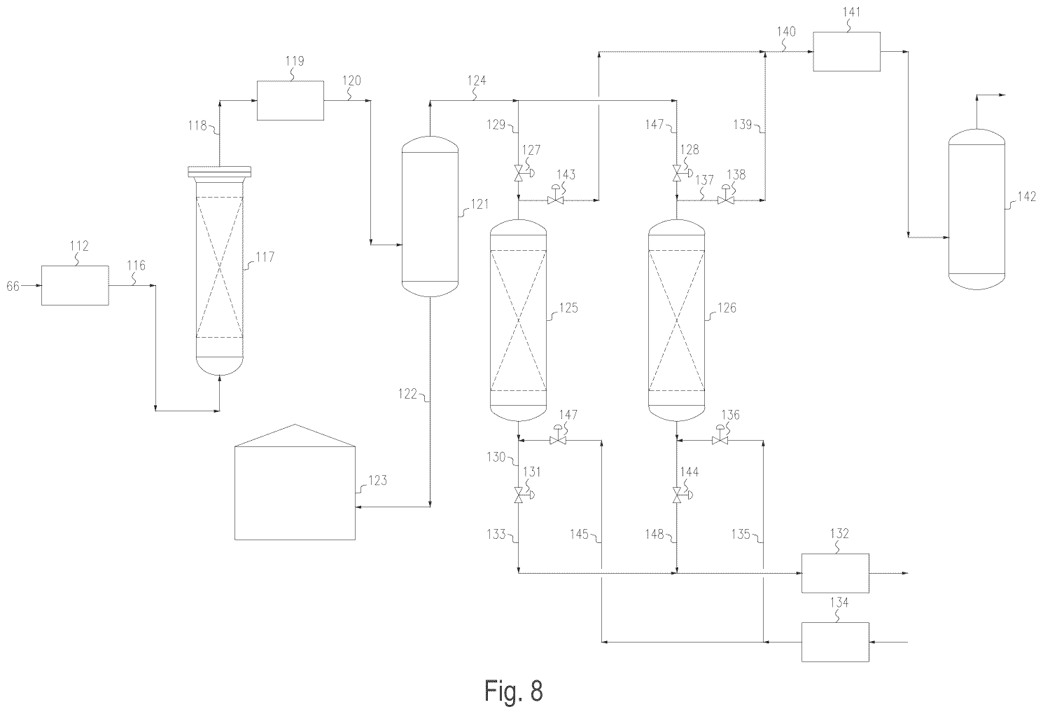

FIG. 8 illustrates the hydrogen oxidation and conversion to water and removal process. The unrefined helium gas stream that is comprised mostly of helium and nitrogen with trace amounts of hydrogen, argon, CO₂ and neon, flows via line (66) into a hydrogen reactor preheater (112). The hydrogen reactor preheater is designed to heat the gas mixture in the stream to a temperature range of 95 and 400 deg F. Following gas heating, the hot unrefined helium gas stream flows via line (116) into a hydrogen oxidation reactor (117). The hydrogen oxidation reactor (117) is filled with a catalyst specifically designed to react hydrogen with oxygen to convert hydrogen into water. The reacted gas, together with any water flows out through the top of the hydrogen oxidation reactor as a saturated gas via line (118) through aerial cooler (119) designed to cool the gas to condense the water. The cooled gas stream flows via line (120) into the helium dehydration condenser (121), which acts as a two-phase separator, to separate the condensed water from the gas stream. The condensed water exits from the bottom of the helium dehydration condenser (121) via a line (122) as a water condensate where it is discharged into a produced water storage tank (123).

The dehydrated unrefined helium gas stream flows out through the top of the helium dehydration condenser (121) via a line (124) into the downstream mole sieve dehydration System. The mole sieve dehydration system comprises two beds (bed A (125) and bed B (126)) equipped with a series of automated open and close valves on the inlet and outlet of each bed designed to allow the beds to cycle back and forth between the modes adsorption and desorption, also referred to as regeneration. Located on the inlet of bed A (125) and bed B (126) are automated open and close valves. An automated valve A (127) located on the inlet of bed A and automated valve B (128) located on the inlet of bed B. When bed A (125) is in the adsorption mode, saturated helium unrefined gas flows via line (129) into bed A where the moisture within the gas is removed through adsorption onto the media. The dehydrated unrefined helium gas stream flows out through the bottom of bed A via line (130) through automated valve B (131) in the open position into a dry gas dust filter (132) via line (133) designed to remove any particulate carryover in the gas. Simultaneously, hot regen gas, comprised of the cooling gas from the outlet of the mole sieve dehydration unit, from the regen heater (134) flows via line (135) through the automated valve E (136) in the open position on the bottom of bed B (126). The hot regen gas upon contact with the media in bed B (126) would cause the adsorbed moisture to be vaporized and carried out through the top of bed B via line (137) through automated valve F (138) into the regen gas manifold (139). From the regen gas manifold, the gas flows via line (140) into aerial cooler (141) where the gas is cooled, allowing the moisture to be condensed and removed in the downstream helium regen gas condenser (142), which acts as a two-phase separator. Each mole sieve bed is equipped with a pressure differential transmitter configured to measure the pressure loss across the bed. When the pressure loss in bed A, while in the adsorption mode, reaches its set-point pressure, bed A would automatically switch over from adsorption mode to regeneration mode. To do so, automated valve A (127) would close, while automated valve C (143) would open. similarly, automated valve B (136) would close, while automated valve D (147) would open, allowing hot regen gas to flow via line (145) in through the bottom of bed A to regenerate the media. At the same time bed B would automatically switch over to from regeneration mode to adsorption mode. To do so, automated valve E (138) would close, while automated valve G (128) would open, similarly, automated valve F (136) would close, while automated valve H (144) would open, allowing helium unrefined gas to flow via line (147) in through the top of bed B for moisture removal from the unrefined gas. Following moisture removal, the dehydrated helium refined gas flows via line (148) into a downstream dust filter (132), for removal any carryover particulate in the gas stream from the molecular sieve dehydration unit (149).

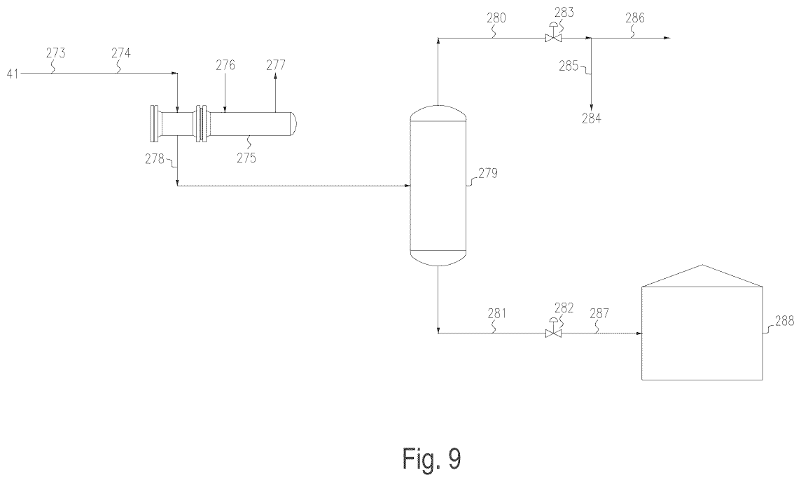

FIG. 9 illustrates the fuel gas and condensate production process, within the helium separation and recovery process of the present invention. As previously discussed, the hydrocarbon absorber produces a liquid hydrocarbon stream that contains the C1+ components in addition to some residual liquefied nitrogen, from where the liquid hydrocarbon stream flows from the bottom of the hydrocarbon absorber column via line back into the brazed aluminum heat exchanger where the cold liquid hydrocarbon stream is used for inlet feed gas cooling. Heat that is cross exchanged within the brazed aluminum heat exchanger is sufficient only in an amount to begin the vaporization the light end hydrocarbons, necessary to separate the fuel gas fraction from the heavy hydrocarbon condensate fraction. A partially liquefied hydrocarbon stream (273) from the brazed aluminum heat exchanger flows via line (274) into fuel gas heat exchanger (275) from where the hydrocarbon stream is further heated using a heat medium (276) from the process heater to vaporize the light end hydrocarbons from the heavy hydrocarbons, the purpose of which is to allow for the separation of the two fractions within the fuel gas scrubber (279). The cooled heat medium, following having exchanged its heat into the partially liquefied hydrocarbon stream (273), leaves the fuel gas heat exchanger (275) via line (276). From the fuel gas heat exchanger (275) the partially liquefied hydrocarbon stream, now in a two-phase flow, flows via line (278) into the fuel gas scrubber (279), where the light and heavy hydrocarbon fractions are separated. The light hydrocarbon fraction, comprising of the fuel gas, is used to power the process heater, which in turn is designed to supply the heat medium for the entire process. The light hydrocarbon fraction is recovered as a gas from the top of the fuel gas scrubber (279), where the gas flows out via line (280) into a fuel gas header from where the gas flows through pressure valve (283), designed to regulate the pressure and gas supply in the downstream supply header (286) configured to supply fuel gas to all the different end users. During start-up, when there is no fuel gas from the process, an alternate external fuel gas supply (284), such as propane, is used, where the alternate fuel gas supply flows via line (285) into the downstream fuel gas supply header (286). The heavy hydrocarbon fraction, comprising of a liquid heavy hydrocarbon fraction, unsuitable for use as a fuel gas, referred to as a condensate, is recovered from the bottom of the fuel gas scrubber (279), where the condensate flows via line (281) through level valve (282), designed to regulate the liquid level on the fuel gas scrubber (279). From the level valve (282) the condensate flows via line (287) into the condensate storage tank (288). A novel embodiment of the invention is the separation and recovery of the hydrocarbon contamination from the inlet feed gas to produce a high purity stream fuel gas and condensate, where the fuel gas, which if in sufficient quantity, would eliminate the process reliance on an external fuel gas supply required to operate the process heater, thereby reducing the process operating cost, in addition to eliminating the need to either flare this gas or preventing the release this gas to the atmosphere where it is known to contribute to undesirable greenhouse gas production that can have a negative environmental effect.

While particular embodiments of the present invention have been illustrated and described, the scope of the claims should not be limited by the embodiments set forth in the examples/drawings, but should be given the broadest interpretation consistent with the description as a whole.

1. A process for separating and recovering helium from a nitrogen rich gas feed stream comprising up to 10 mole % of said helium, and other components comprising CO₂, H₂, N₂, O₂, Ar and water, the process comprising:
a. providing a high-pressure gas feed stream having a pressure from 300 to 3000 psi;
b. removing CO₂ from the high-pressure gas feed stream to obtain a treated high-pressure gas stream;
c. drying the treated high-pressure gas stream to obtain a dehydrated high-pressure gas stream;
d. subjecting the dehydrated high-pressure gas stream to a cryogenic fractionation process comprising:
i) cooling the dehydrated high-pressure gas stream through a heat exchanger;
ii) reducing pressure of the dehydrated high-pressure gas stream to 100-200 psi via a Joule-Thompson's process to obtain a first partially liquefied gas stream comprising nitrogen and hydrocarbons, and gaseous components comprising helium;
iii) subjecting the first partially liquefied gas stream to at least one gas-liquid separation process to obtain at least one liquid stream comprising condensed nitrogen and/or condensed hydrocarbons, and an unrefined helium gas stream comprising helium and a residual amount of gaseous components comprising H₂, N₂, and/or Ar;
e) recycling the at least one liquid stream obtained in step iii) to the heat exchanger for use as cooling refrigerant to cool the dehydrated high-pressure gas stream via heat exchange;
f) purifying the unrefined helium gas stream using pressure swing adsorption (PSA) and/or membrane separation process to obtain a helium product stream having a purity of 98.0 mole % or more.

2. The process of claim 1, wherein the gas-liquid separation process comprises passing at least a portion of the first partially liquefied gas stream through a liquid absorber to obtain a liquid stream comprising the condensed nitrogen and condensed hydrocarbons.

3. The process of claim 2, further comprising using a slip stream from the dehydrated high-pressure gas stream for heating at least a portion of the liquid stream to vaporize and separate any residual helium from the liquid stream.

4. The process of claim 2, further comprising recycling at least a portion of the liquid stream to the heat exchanger for cooling the dehydrated high-pressure gas stream via heat exchange.

5. The process of claim 1, wherein the gas-liquid separation process comprises passing a portion of the partially liquefied gas stream through a hydrocarbon absorber, to obtain a first liquid stream comprising condensed hydrocarbons, and a vapor stream comprising nitrogen, helium and other gaseous components;
wherein the process further comprises cooling the vapor stream through the heat exchanger and/or by reducing pressure of the vapor stream via a Joule-Thompson's process to obtain a second partially liquefied gas stream comprising the nitrogen, the helium and the other gaseous components; and
passing the second partially liquefied gas stream (through a nitrogen absorber to obtain a second liquid stream comprising the condensed nitrogen, and the unrefined helium gas stream.

6. The process of claim 5, further comprising using a slip stream from the dehydrated high-pressure gas stream for heating at least a portion of the first liquid stream to vaporize and separate any residual nitrogen from the condensed hydrocarbons.

7. The process of claim 5, further comprising using a slip stream from the dehydrated high-pressure gas stream for heating at least a portion of the second liquid stream to vaporize and separate any residual helium from the liquid stream.

8. The process of claim 5, further comprising recycling at least a portion of the first liquid stream to the heat exchanger for cooling the dehydrated high-pressure gas stream via heat exchange.

9. The process of claim 5, further comprising recycling at least a portion of the second liquid stream to the heat exchanger for cooling the dehydrated high-pressure gas stream via heat exchange.

10. The process of claim 5, further comprising processing at least a portion of the first liquid stream to obtain a fuel gas stream for use as a heat source within the process.

11. The process of claim 10, further comprising recovering one or more heavy hydrocarbons from the liquid stream as saleable byproduct(s).

12. The process of claim 1, further comprising passing the at least one liquid stream obtained in step iii) through a level valve for pressure reduction for flashing and heating the liquid nitrogen within the heat exchanger to draw heat from the system.

13. The process of claim 1, wherein the process further comprises recycling an exhaust stream from the PSA process and/or the membrane separation process to steps ii) and/or iii) of the cryogenic fractionation step to recover residual helium from the exhaust stream.

14. The process of claim 1, further comprising reacting the unrefined helium gas stream obtained in step d) with oxygen in the presence of a catalyst to convert the hydrogen into water, and removing the produced water from the helium gas stream.

15. The process of claim 1, wherein the process further comprises compressing the unrefined helium gas stream prior to the PSA process.

16. The process of claim 1, further comprising recovering separated CO₂ and processing same to obtain as high purity CO₂ stream with purity of greater than 98% mole.

17. The process of claim 1, wherein the CO₂ removal comprises contacting the high-pressure gas feed stream with a lean amine and/or passing through an absorption or adsorption media.

18. The process of claim 1, wherein the drying of the treated high-pressure gas stream comprises passing the treated high-pressure gas stream through an absorption or adsorption media.

19. The process of claim 1, wherein the pressure swing adsorption process is programmed to cycle through twelve separate steps before repeating the cycle, wherein each steps is designed to recycle a respective PSA exhaust stream back to the cryogenic fractionation step.
